(19) United States
(12) Patent Application Publication
(10) Pub. No.: US 2025/0222671 A1
(43) Pub. Date: Jul. 10, 2025

(54) Temperature-Controllable Calender Roller for Manufacturing an Electrode Track Using the Dry Electrode Process

(71) Applicant: Matthews International Corporation, Pittsburgh, PA (US)

(72) Inventors: Marco STARTMANN, Vreden (DE); Rene WOLTERS, Stadtlohn (DE); Christoph FASTRING, Velen Ramsdorf (DE); Stefan TERBILLE, Vreden (DE); Thomas HACKFORT, Ahaus-Alstätte (DE); Wildrich SCHWIETERS, Ahaus (DE)

(21) Appl. No.: 18/728,967

(22) PCT Filed: Jul. 8, 2022
(86) PCT No.: PCT/DE2022/100492

§ 371 Date: Jul. 15, 2024

Related U.S. Application Data
(60) Provisional application No. 63/300,310, filed on Jan. 18, 2022.

(51) Int. Cl. B30B 15/34; B30B 3/00; H01M 4/04

(52) U.S. Cl. CPC B30B 15/34; B30B 3/00; H01M 4/0435

(57) ABSTRACT

The invention relates to a temperature-controllable calender roller for manufacturing an electrode track using the dry electrode method; having a roller body and two roller journals extending away from the end face thereof; and having a fluid channel arrangement for temperature control of the roller body, which has a central bore extending axially at least in sections through the roller body and through at least one of the roller journals and a plurality of temperature control channels distributed over the circumference of the roller body, extending below the roller body surface and parallel thereto, which are fluidically coupled to the central bore; and having an inlet line and an outlet line for a thermal fluid, which are connected to the fluid channel arrangement, wherein the inlet line has a feed pipe extending at least in sections into the central bore for introducing the thermal fluid into the fluid channel arrangement, and wherein the outlet line is fluidically coupled to an outlet gap of the fluid channel arrangement formed between the outside of the feed pipe and the inner diameter of the central bore.

The invention relates to a temperature-controllable calender roller for producing an electrode track using the dry electrode process with a roller body and two roller journals extending away from the end face thereof, wherein a fluid channel arrangement is provided in the interior of the calender roller.

A hollow roller with a temperature control device is known from document DE 33 21 122 A1. This has a plurality of passages extending parallel to the roller surface for conducting a temperature control fluid and a central bore connected to the passages, by means of which the passages are supplied with the fluid.

The manufacturing of electrode tracks using the dry electrode process requires process temperatures above 100° C. Therefore, it is necessary to heat the calender roller used to manufacture the electrode track. However, one problem with heating a roller is that in certain circumstances the roller surface has a temperature gradient over its axial course, which, for example, produces a higher temperature in a central area of the roller than in the outer areas at the edge. This results in the more heated roller material expanding more in the middle than the less heated material in the edge areas and therefore crowning occurring, i.e., a cross-sectional thickening that deviates from the cylindrical shape. However, electrode tracks for battery cells have the requirement for the most homogeneous possible thickness across their width. Therefore, it is necessary to avoid the crowning that occurs upon heating of the roller.

It is therefore an object of the present invention to improve a temperature-controllable calender roller for manufacturing an electrode track using the dry electrode process in such a way that it has a uniform temperature profile on its roller surface.

The invention is achieved by a temperature-controllable calender roller having the features of claim 1. Further advantageous embodiments of the invention are described in the dependent claims.

Accordingly, it is provided that the calender roller has a fluid channel arrangement for temperature control of the roller body, which has a central bore extending axially at least in sections through the roller body and through at least one of the roller journals, as well as a plurality of temperature control channels distributed over the circumference of the roller body, extending below the roller body surface and parallel thereto, which are fluidically coupled to the central bore. Furthermore, the calender roller has an inlet line and an outlet line for a thermal fluid, which are connected to the fluid channel arrangement, wherein the inlet line has a feed pipe extending at least partially into the central bore for introducing the thermal fluid into the fluid channel arrangement and wherein the outlet line is fluidically coupled to an outlet gap of the fluid channel arrangement formed between the outside of the feed pipe and the inner diameter of the central bore. The fluid channel arrangement can be used, for example, to heat the roller to a provided process temperature by means of a thermal fluid such as oil. Alternatively, it can be provided, for example for the case that the calender roller needs to be removed for maintenance reasons, that a cooling medium, possibly the same as the thermal fluid used for heating, is conducted through the fluid channel arrangement so that the cooling time of the roller can be reduced until it is ready for removal.

It can be provided that the inlet line and the outlet line open into the same roller journal of the calender roller and the temperature control channels are fluidically coupled to the feed pipe via a plurality of inlet channels and to the outlet gap via a plurality of outlet channels, wherein the inlet channels open into the central bore on a side facing away from the inlet line and the outlet channels open into the outlet gap.

Furthermore, it can be provided that the feed pipe extends axially into the central bore beyond the mouth openings of the inlet channels. The feed pipe can, for example, extend axially to the opposite roller journal or into it. This results in better circulation of the thermal fluid in the roller journal in relation to a shorter feed pipe. Furthermore, in the area between the outlet of the feed pipe and the mouth area of the inlet channels, an inlet gap can be formed between the outside of the feed pipe and the inside of the central bore, through which the thermal fluid can flow towards the mouth area of the inlet channels after leaving the outlet of the feed pipe.

In addition, it can be provided that the central bore is a through bore extending through both roller journals and the roller body and that the feed pipe extends into the central bore up into the area of the roller journal opposite to the inlet line. Between the outlet of the feed pipe and the end of the central bore, which can be closed by a cover, a space can be provided through which thermal fluid can flow. Heating of the entire roller, including the roller journal, can thus effectively be achieved, so that a temperature gradient between the roller body and the roller journal is avoided, so that the temperature distribution along the surface of the roller is more uniform.

It is conceivable that the mouth area of the inlet channels is sealed off from the mouth area of the outlet channels by means of at least one sealing bushing arranged between these areas on the outside of the feed pipe. Furthermore, it is conceivable that two spaced-apart sealing bushings are arranged on the outside of the feed pipe between the mouth area of the inlet channels and the mouth area of the outlet channels, due to which the section enclosed between the sealing bushings between the outside of the feed pipe and the inner diameter of the central bore is free of thermal fluid.

It is also conceivable that an odd-numbered plurality of temperature control channels spaced apart parallel to one another in the roller rotation direction are arranged between each inlet channel and the outlet channel assigned thereto, through which the thermal fluid is guided in a serpentine manner in the axial direction according to the number of temperature control channels. This allows the number of temperature control channels extending beneath the roller surface to be maximized, since the maximum number of inlet and outlet channels leading into the central bore is limited by the diameter ratio of the central bore and the inlet and outlet channels.

It can be provided that the temperature control channels are each designed as through holes guided through the roller body and adjacent temperature control channels are connected to one another by means of essentially tangentially extending, axially sealed grooves introduced into the end face.

Furthermore, it can be provided that the roller body has an axial annular groove in the area of the temperature control channels on both end faces of the roller body, into which a cover cap having the grooves and bores is inserted, which is axially sealed using a sealing element. The sealing elements can essentially completely cover the end surfaces of the roller body. The sealing elements can also have a low thermal conductivity of less than 3 W/(m·K). This allows radiation of heat along the end faces or air convection to be avoided, so that the heat gradient of the fluid flowing through the roller along the distance it travels through the roller is as small as possible. The holes can each adjoin in an aligned manner with the temperature control channels connected to an inlet or outlet channel, so that the contact area between the cover cap and the thermal fluid is increased.

In addition, it can be provided that the central bore is closed at the end with a cover on the side opposite to the inlet line.

It is conceivable that the inlet channels extend axially from the inlet side and radially away from the central bore in a first diagonal direction and that the outlet channels extend axially towards the inlet side and radially away from the central bore in a second diagonal direction.

Furthermore, it is conceivable that the fluid channel arrangement has an insulating element, at least in the area of the roller journal comprising this arrangement, for thermally shielding the fluid channel arrangement from the roller journal.

It is also conceivable that the insulating element consists of a material having a thermal conductivity of less than 0.3 W/(m·K), such as PTFE.

In addition, it can be provided that the fluid channel arrangement extends at least in some sections through both roller journals and that the fluid channel arrangement has an insulating element in the area of both roller journals for thermally shielding the fluid channel arrangement from the respective roller journal.

It can be provided that the at least one insulating element in the form of an insulating sleeve lining the central bore is inserted into the central bore.

The invention furthermore relates to a process for manufacturing an electrode track, comprising the following steps:
providing a powdered electrode precursor material and at least one calender roller, wherein the calender roller has a fluid channel arrangement for temperature control of the calender roller;
heating the calender roller by means of conducting a fluid through the fluid channel arrangement;
contacting the calender roller with the powdered electrode precursor material.

It can be provided that the fluid is an oil. It is conceivable that the fluid is kept at a temperature of 30° C. to 200° C. It is furthermore conceivable that the fluid is kept at a temperature of 60° C. to 150° C. In addition, it can be provided that the fluid is kept at a temperature of 90° C. to 120° C.

Furthermore, it can be provided that a cooling medium is conducted through the fluid channel arrangement to cool the calender roller, wherein the temperature of the cooling medium is kept at a temperature which is lower than the temperature of the calender roller. The invention furthermore relates to a dry electrode produced by a process according to any one of claims 17-22. The dry electrode can have a thickness tolerance of less than 1 μm.

The invention furthermore relates to a process for manufacturing a calender roller, wherein the process comprises:
manufacturing one or more calender roller parts; and
connecting the one or more calender roller parts; wherein:
the one or more calender roller parts comprise at least one feed pipe, at least one temperature control channel, and at least one outlet line;
wherein the calender roller has a first end and a second end; and
the at least one feed pipe extends from the first end into the second end.

It can furthermore be provided that the one or more calender roller parts are manufactured by CNC machining, forging, investment casting, injection molding, die casting, additive manufacturing, or combinations thereof.

In addition, it can be provided that the one or more calender roller parts are connected by metal gas welding, arc welding, tungsten inert gas welding, flux core welding, soldering, mixing, adhesive bonding, or combinations thereof.

Furthermore, the manufacture of at least one insulating sleeve and the connection of the insulating sleeve to the one or more calender roller parts may be provided, wherein the at least one insulating sleeve may be manufactured by transfer molding, injection molding, melt molding, compression molding, vacuum forming, pultrusion, or combinations thereof; and the at least one insulating sleeve may be connected to the one or more calender roller parts by adhesive bonding, mechanical fastening, or combinations thereof.

Furthermore, the manufacture of at least one insulating layer and the connection of the insulating layer to the one or more calender roller parts may be provided, wherein the at least one insulating layer may be manufactured by transfer molding, injection molding, melt molding, compression molding, vacuum forming, pultrusion, or combinations thereof; and the at least one insulating layer may be connected to the one or more calender roller parts by adhesive bonding, mechanical fastening, or combinations thereof.

Furthermore, it can be provided that the calender roller has a surface, furthermore comprising treating the surface of the calender roller, wherein the surface of the calender roller is treated using a micro-etching treatment, a laser engraving treatment, a superpolishing treatment, or combinations thereof.

Exemplary embodiments of the invention are explained on the basis of the following figures. In the figures:

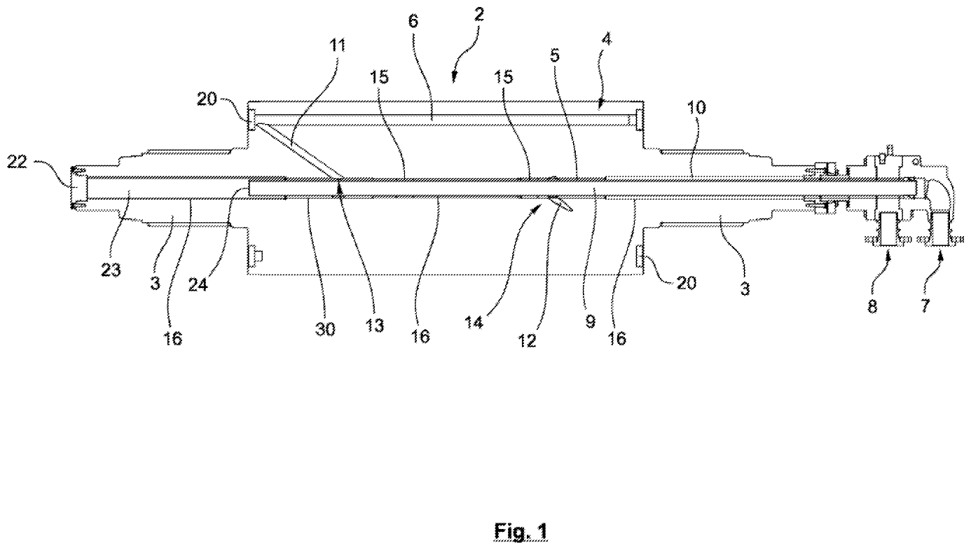

FIG. 1 shows a cross-sectional view of an embodiment of the temperature-controllable calender roller according to the invention;

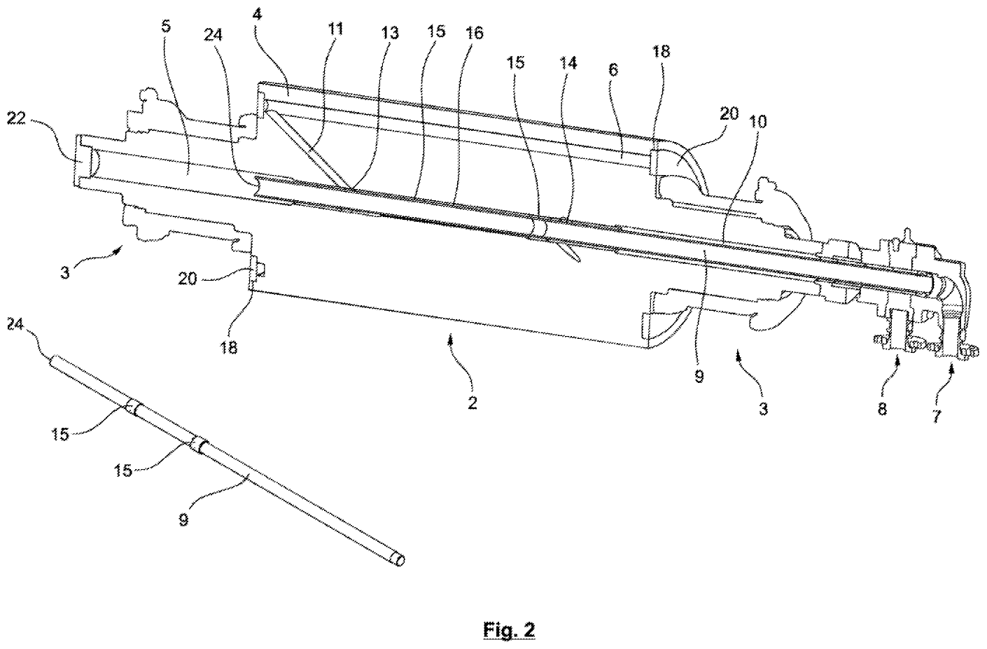

FIG. 2 shows a perspective view of an embodiment of the temperature-controllable calender roller according to the invention;

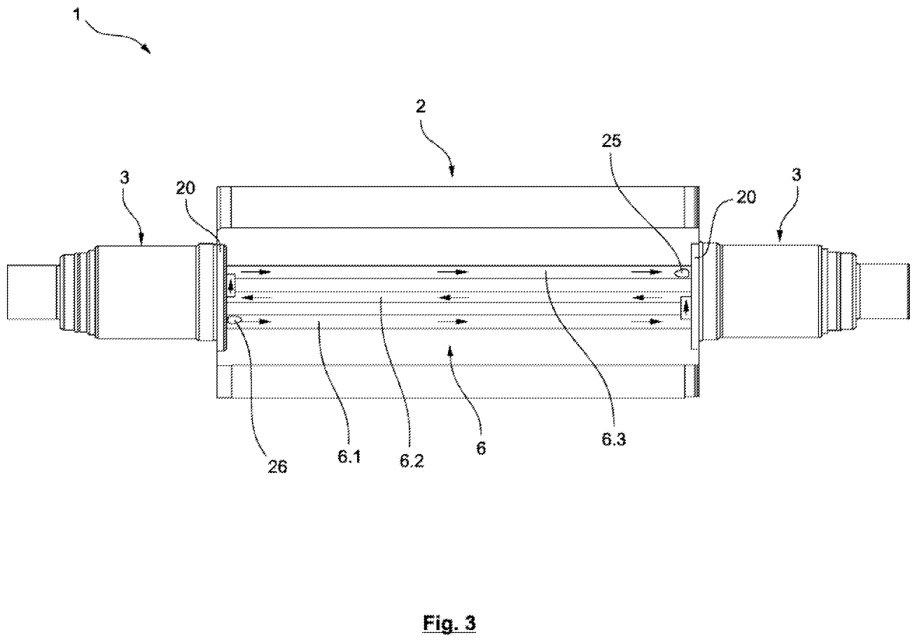

FIG. 3 shows a cross-sectional view of an embodiment of the temperature-controllable calender roller according to the invention having temperature control channels extending in parallel;

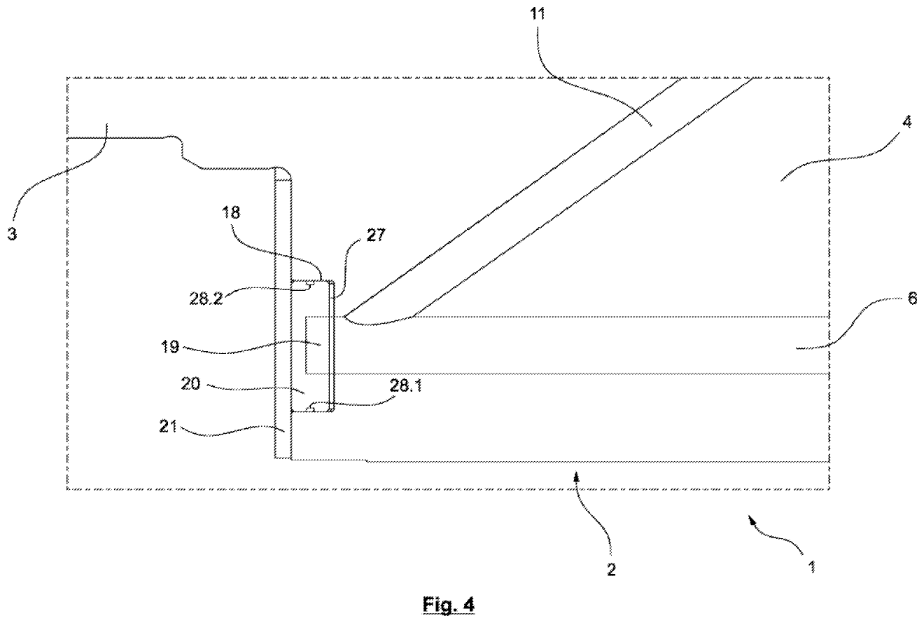

FIG. 4 shows a cross-sectional view of an intersection point between a temperature control channel and an inlet channel;

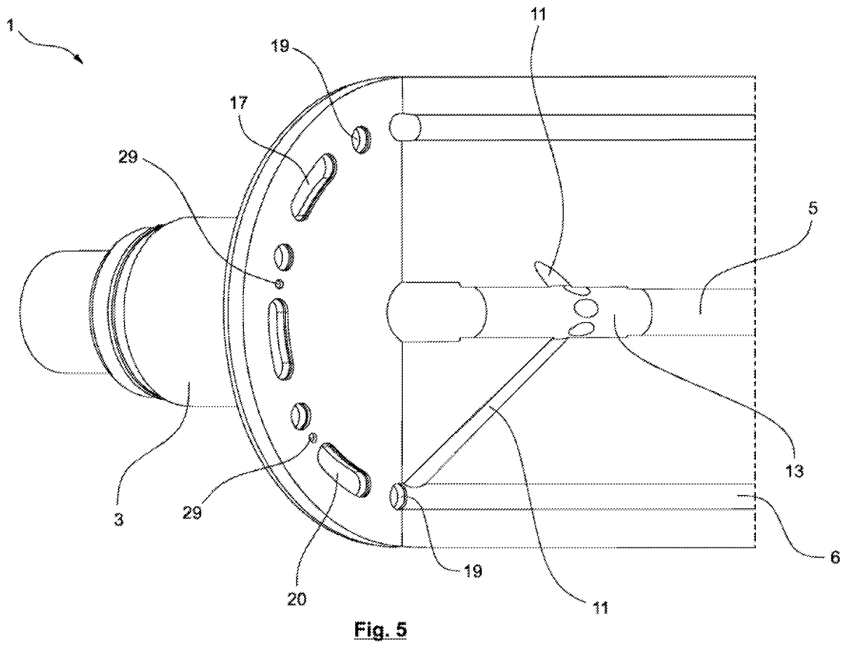

FIG. 5 shows a detailed view of connecting grooves of temperature control channels in half section and;

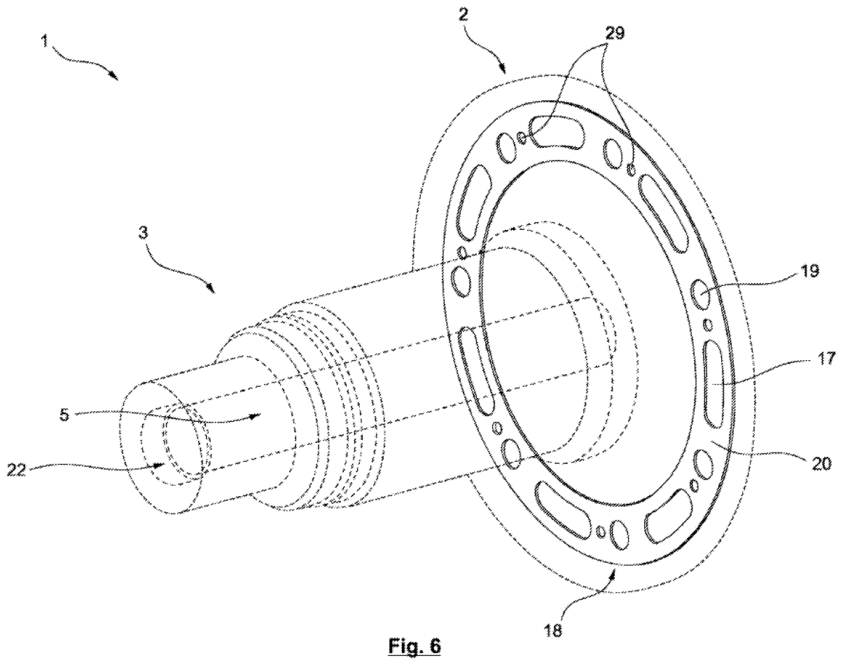

FIG. 6 shows a perspective view of a roller journal and a cover cap mounted on the end face of a roller body;

FIG. 7 shows a flow chart of a process for manufacturing a dry electrode;

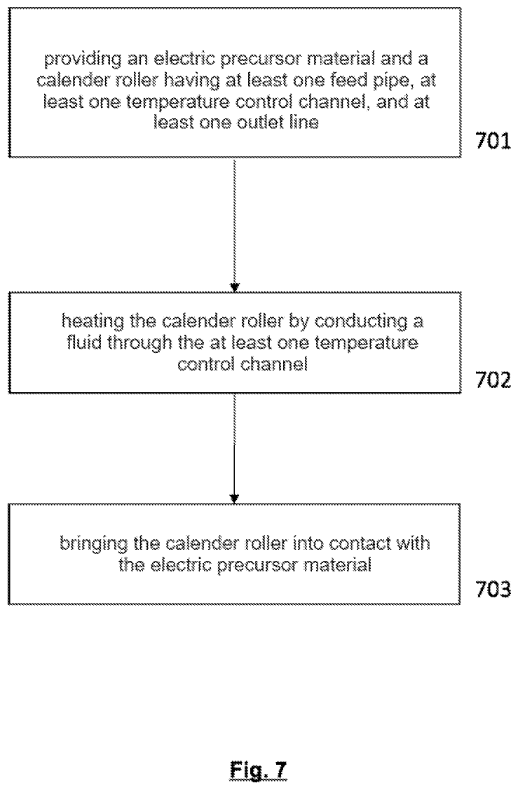

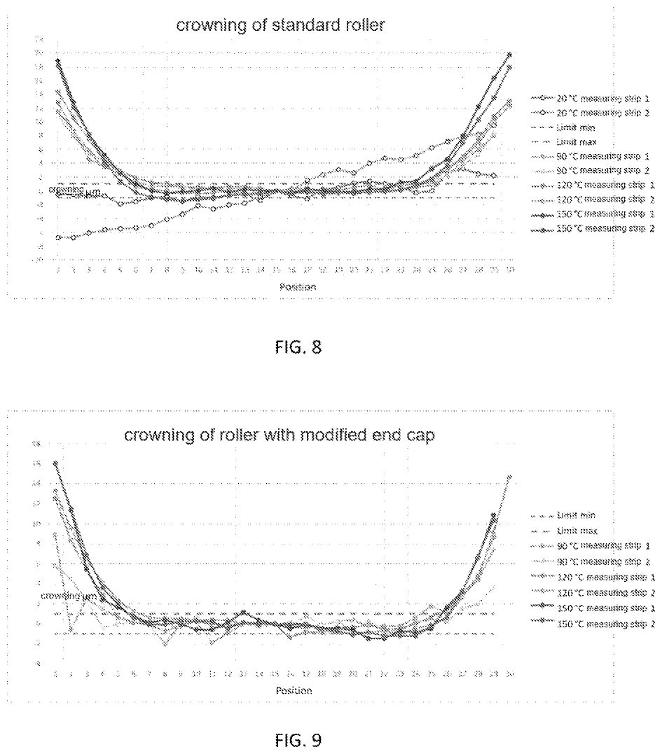

FIG. 8 shows a diagram having measurement results of a thermal crowning test of a standard roller;

FIG. 9 shows a diagram having measurement results of a thermal crowning test of a roller having modified end caps;

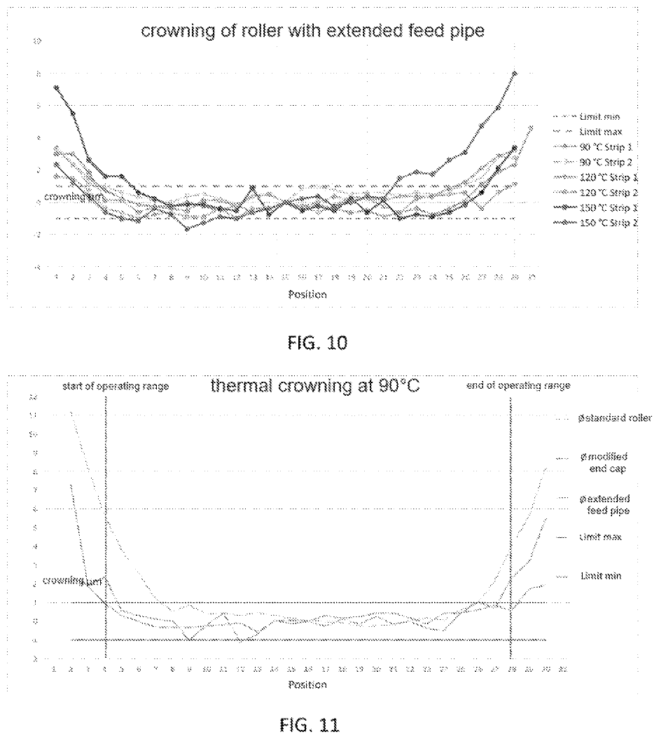

FIG. 10 shows a diagram having measurement results of a thermal crowning test of a roller having an extended feed pipe;

FIG. 11 shows a diagram having measurement results of a thermal crowning test of a calender roller;

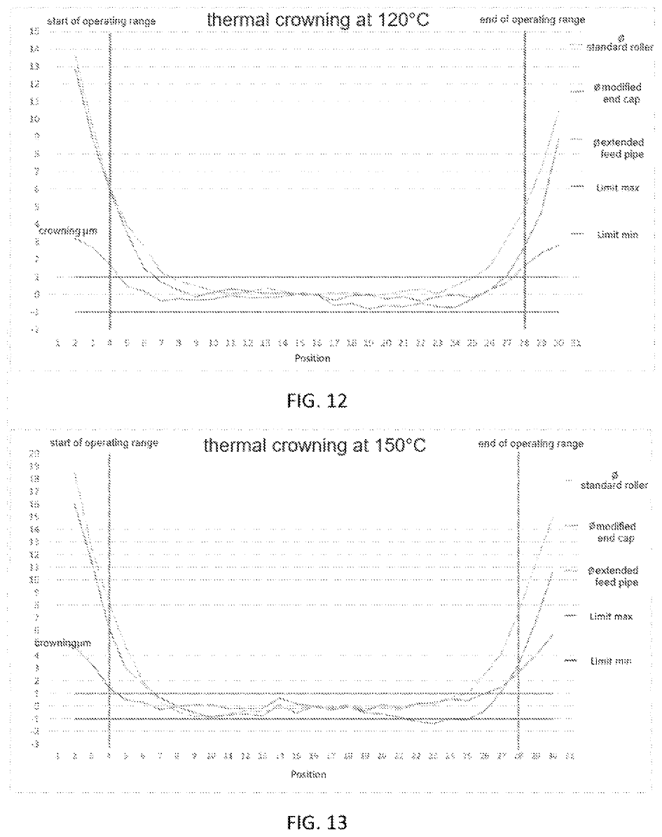

FIG. 12 shows a diagram having measurement results of a thermal crowning test of a calender roller;

FIG. 13 shows a diagram having measurement results of a thermal crowning test of a calender roller.

The temperature-controllable calender roller 1 shown in FIG. 1 has a roller body 2 having two roller journals 3 projecting from it in opposite directions. A fluid channel arrangement 4 is arranged in the interior of the roller 1, which on the one hand comprises a central bore 5 extending through the roller 1 in the axial direction X and a plurality of temperature control channels 6 distributed over the roller circumference and arranged below the roller surface and parallel thereto. The central bore 5 is fluidically connected to the temperature control channels 6 via a plurality of diagonally extending inlet channels 11 and a plurality of outlet channels 12 extending diagonally in the opposite direction. The inlet channels 11 open into the central bore 5 in a first mouth area 13 and the outlet channels 12 open in a second mouth area 14. A feed pipe 9 is inserted into the central bore 5, which is fluidically coupled to an inlet line 7 and through which a thermal fluid is fed into the roller 1. The length of the feed pipe 9 is dimensioned such that it projects beyond both mouth areas 13, 14 and the outlet 24 of the feed pipe 9 projects beyond the first mouth area 13 of the inlet channels 11. In the first and second mouth areas 13, 14, the feed pipe 9 has a diameter difference in relation to the central bore 5 such that a gap is formed between the outer diameter of the feed pipe 9 and the inner diameter of the central bore 5, namely an inlet gap 30 between the outlet 24 and the first mouth area 13 and an outlet gap 10 between the second mouth area 14 up to the axial end of the roller journal 3 on the right in the image. Between the first and the second mouth area 13, 14, the feed pipe 9 is sealed in relation the central bore 5 by means of two sealing bushings 15, so that a backflow of thermal fluid from the first to the second mouth area 13, 14 through the central bore 5 is prevented. The sealing bushings 15 form a section 16 enclosed therebetween. Thus, the thermal fluid first flows through the inlet line 7 into the feed pipe 9, then along the feed pipe 9 once transversely through the central bore 5 to the outlet 24 of the feed pipe 9. Behind the outlet 24, the thermal fluid first flows into the section of the central bore 5 extending into the left roller journal 3, which is closed at the end using a cover 22. This section also has an insulating sleeve 23 made of Teflon which lines the central bore 5 and thermally seals the central bore 5 in relation to the roller journal 3. When this space is filled, the thermal fluid flows in the opposite direction into the inlet gap 30 between the feed pipe 9 and the central bore 5 and from there into the individual inlet channels 11. The thermal fluid flows into the temperature control channels 6 via the inlet channels 11 opening into the temperature control channels 6 and thus in parallel below the roller surface, so that the surface is heated. After flowing through the temperature control channels 6, the thermal fluid flows into the outlet channels 12 and via these into the discharge gap 10, via which the thermal fluid is fed to a outlet line 8, which is located on the same roller journal 3 as the inlet line 7.

FIG. 2 shows a perspective view of a temperature-controllable calender roller 1. In contrast to the configuration shown in FIG. 1, this does not have an insulating sleeve 23, so that both areas of the central bore 5 located inside the roller journal 3 are not thermally sealed in relation to the roller journal 3. Also visible are cover caps 20, each of which is arranged in an axial annular groove 18, which are introduced into the roller body 2 on the end faces on opposite sides. FIG. 2 also shows a detailed view of the feed pipe 9, once in the state installed in the roller 1 and once in a separate representation next to the roller 1. The feed pipe 9 has on the inlet side, i.e., opposite to the outlet 24, a connecting piece for coupling to the inlet line 7. On the outside of the feed pipe 9, two sealing bushings 15 are arranged at a distance from one another, which seal the feed pipe 9 in relation to the central bore. The sealing bushings 15 are also used as sliding bushings to facilitate the installation of the feed pipe 9 in the central bore 5.

FIG. 3 shows a detailed view of the temperature control channels 6 extending beneath the roller surface and illustrates the course of the thermal fluid through the temperature control channels 6. The thermal fluid flows into a first temperature control channel 6.1 extending in the axial direction via an inlet 26, which is fluidically connected to an inlet channel 11 (not shown) associated therewith. The thermal fluid then flows through a groove 17 (not shown) extending in the radial direction in the cover cap 20 opposite to the inlet 26 into a second temperature control channel 6.2, which extends in parallel to the first temperature control channel 6.1 and spaced apart therefrom. In the second temperature control channel 6.2, the thermal fluid now flows in the opposite direction back in the direction of the side of the inlet 26. At the opposite end, a further cover cap 20 is mounted, which has a corresponding groove 17 extending in the radial direction (not shown), which connects the second temperature control channel 6.2 to a third temperature control channel 6.3, which is also arranged parallel to the first and second temperature control channels 6.1, 6.2 and spaced apart from them in the circumferential direction of the roller 1. Through the third temperature control channel 6.3, the thermal fluid flows again away from the inlet side to an outlet 25 located at the end of the third temperature control channel 6.3, through which the thermal fluid flows into an outlet channel 12 (not shown) assigned thereto.

FIG. 4 shows a detailed view of the mouth area between a temperature control channel 6 and an inlet channel 11 of a fluid channel arrangement 4. The temperature control channels 6 are each designed as through bores extending through the roller body 2. In the area in which the temperature control channels 6 open into the end faces of the roller body 2, the roller body has an axial annular groove 18. An annular cover cap 20 is inserted into the annular groove 18, which is screwed to the respective end face of the roller body 2 and has a plurality of blind holes 19 or grooves 17. The blind holes 19 each represent end sections of the respective temperature control channels 6 which protrude into the cover cap 20 and which adjoin the respective blind hole 19. With reference to FIG. 3, the cover cap 20 has such a blind hole 19 on the inlet side of the first temperature control channel 6.1 and on the outlet side of the third temperature control channel 6.3. The blind hole 19 enlarges the contact area between the thermal fluid and the cover cap 20 so that the cap can emit the heat to the roller body 2 more effectively. This means that wherever an inlet channel 11 or an outlet channel 12 flows into a temperature control channel 6, a blind hole 19 is assigned to the temperature control channel 6. A flat seal 27 for axial sealing is arranged between the cover cap 20 and the bottom of the axial annular groove 18. A first O-ring 28.1 is inserted into an outer radial groove of the cover cap 20 and a second O-ring 28.2 is inserted into an inner radial groove of the cover cap 20 in order to seal it radially. A flat sealing element 21 is arranged on the end face on the outside of the cover cap 20 in order to additionally seal the cover cap 20 against external influences. The sealing element 21 covers as large a surface area as possible of the end faces of the roller body 2 in order to minimize heat loss at the end faces. The sealing element 21 consists of an insulating material which has a low thermal conductivity.

FIG. 5 once again illustrates the contact area between the temperature control channels 6 and the cover cap 20 viewed over the circumference of the roller 1. The temperature control channels 6, which are only partially shown, are distributed at regular intervals over the roller circumference and each border on the end face either in one of the blind holes 19 or in one of the grooves 17. Each blind hole 19 is bordered by a temperature control channel 6 and each of the grooves 17 is bordered by two temperature control channels 6, wherein the groove 17 is used to divert the thermal fluid from the one temperature control channel adjacent thereto into the other temperature control channel adjacent thereto. Each temperature control channel arrangement made up of three mutually associated temperature control channels 6.1, 6.2 and 6.3, which share a common inlet channel 11 and a common outlet channel 12, is thus assigned a blind hole 19 and an adjacent groove 17 in each of the opposite cover caps 20. The cover cap 20 is inserted into the axial annular groove 18 introduced into the end face of the roller body and is screwed to the roller body 2 via bores 29 introduced into the cover cap 20.

FIG. 6 shows a perspective view of a roller journal 3 with the roller body adjacent thereto and the cover cap 20 inserted therein, wherein this cap is shown in a half section so that the rear grooves 17 and bores 19 are visible. It can be seen that a bore 19 and a groove 17 are provided alternately and that they are regularly spaced apart from one another.

FIG. 7 shows a flow chart for manufacturing an electrode track. The method comprises providing 701 a dry electrode precursor material and a calender roller comprising at least one feed pipe, at least one temperature control channel, and at least one outlet line, heating 702 the calender roller by conducting a fluid through the at least one temperature control channel, and bringing 703 the calender roller into contact with the dry electrode precursor material. In some embodiments, the calender roller 702 is heated by conducting a fluid through the at least one temperature control channel, wherein the fluid is maintained at a temperature higher than that of the environment immediately surrounding the calender roller. The fluid may be any fluid that is suitable for heating the calender roller and is known to the person skilled in the art.

In some embodiments, the fluid is an oil. In some embodiments, the fluid is kept at a temperature of about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 160° C., about 170° C., about 180° C., about 190° C., about 200° C., or at a temperature value or range of values between two of these values. In some embodiments, the method furthermore comprises cooling the calender roller by passing a cooling fluid through the at least one temperature control channel, wherein the cooling fluid is kept at a temperature lower than the temperature of the calender roller. In some embodiments, the cooling gas is air.

Processes for manufacturing a calender roller can be compiled, which comprises at least one feed pipe, at least one temperature control channel, and at least one outlet line. The process comprises manufacturing one or more calender roller parts, wherein the one or more calender roller parts comprise at least one feed pipe, at least one temperature control channel, and at least one outlet line, and connecting the one or more calender roller parts. In some embodiments, the calender roller has a first end and a second end, and the at least one feed pipe extends from the first end into the second end. The calender roller can be manufactured using any manufacturing process known in the art. In some embodiments, the calender roller is manufactured by CNC machining, forging, investment casting, injection molding, die casting, additive manufacturing, or combinations thereof.

In some embodiments, the one or more calender roller parts can be connected by any method that would appear suitable to one skilled in the art for connecting metal parts. For example, the one or more calender roller parts may be connected by gas metal arc welding, arc welding, tungsten inert gas welding, flux core welding, brazing, mixing, adhesive bonding, or combinations thereof.

In some embodiments, the process furthermore comprises manufacturing at least one insulating sleeve. The at least one insulating sleeve can be manufactured by any manufacturing process known to the person skilled in the art. In some embodiments, the at least one insulating sleeve is manufactured by transfer molding, injection molding, melt molding, compression molding, vacuum forming, pultrusion, or combinations thereof. In some embodiments, the at least one insulating sleeve is connected to the one or more calender roller parts. The at least one insulating sleeve may be connected to the one or more calender roller parts by any process known to one skilled in the art in this area. For example, the at least one insulating sleeve can be connected to the one or more calender roller parts by adhesive bonding, mechanical fastening, or combinations thereof.

In some embodiments, the process furthermore comprises manufacturing at least one insulating layer. The at least one insulating layer can be manufactured by any manufacturing process known to the person skilled in the art. In some embodiments, the at least one insulating layer is manufactured by transfer molding, injection molding, melt molding, compression molding, vacuum forming, pultrusion, or combinations thereof. In some embodiments, the at least one insulating layer is connected to the one or more calender roller parts. The at least one insulating layer may be connected to the one or more calender roller parts by any process known to one skilled in the art in this area. For example, the at least one insulating layer can be connected to the one or more calender roller parts by adhesive bonding, mechanical fastening, or combinations thereof.

In some embodiments, the method furthermore comprises treating the surface of the calender roller after the manufacture of the calender roller. In some embodiments, the surface of the calender roller is treated using a micro-etching treatment, a laser engraving treatment, a super-polishing treatment, or combinations thereof. The surface of metals often has scratches and defects that can negatively affect the efficiency of the electrodes produced by the calender roller. By combining micro-etching and laser engraving, material on the metal surface is removed and the defects are eliminated.

The superpolishing treatment reduces the surface roughness of the roller by eliminating surface defects. In some embodiments, the entire surface of the roller is treated using the superpolishing. In some embodiments, the superpolishing treatment is applied to a part of the roller surface. In some embodiments, the average surface roughness of the roller is less than about 0.1 μm, less than about 0.09 μm, less than about 0.08 μm, less than about 0.07 μm, less than about 0.06 μm, less than about 0.05 μm, less than about 0.04 μm, less than about 0.03 μm, less than about 0.02 μm, or less than about 0.01 μm.

### EXAMPLES

### Example 1: Manufacturing of Calender Rollers

The calender rollers were prepared by cleaning the surface of the rollers to remove contaminants, and the heating system and hydraulic units were turned on. A first set of nickel foam strips was then placed on the surface of the calender rollers. Each of the nickel foam strips had a width of 10 mm and a length of 300 mm. The strips were applied along the entire length of the roller with a distance of 50 mm between the individual strips. In this way, 31 strips were distributed over the entire length of the roller, wherein each strip corresponded to a position on the roller. A second set of nickel foam strips was similarly applied to the roller opposite to the first set of nickel foam strips. Each roller was then placed next to a calender roller and rotated until each of the nickel foam strips passed through the nip. The rollers were rotated at a speed of 2 m/min, with a tensile force of 150 KN and a distance between the rollers of 350 μm. Each of the nickel foam strips was then removed from the roller and the thickness of the strips was measured. The tests were conducted using three variations of rollers, including standard rollers, rollers having modified end caps, and rollers with extended feed pipes.

### Example 2: Standard Calender Rollers

The test was carried out on two standard rollers according to the parameters described in Example 1. The tests were carried out with the roller heated to 20° C., 90° C., 120° C., and 150° C. The results from each of the nickel foam strips and the measurements from each roller were averaged and are shown in FIG. 8.

### Example 3: Calender Rollers Having Modified End Cap

The tests were carried out on two rollers according to the parameters described in Example 1. The first roller tested was a standard roller. The second roller tested had a modified end cap. On the second roller, the cap was milled and the flat seal was removed. During the tests, the roller was heated to 20° C., 90° C., 120° C., and 150° C. The results from each of the nickel foam strips and the measurements from each roller were averaged and are shown in FIG. 9.

### Example 4: Calender Rollers Having an Extended Feed Pipe

The tests were carried out on two rollers according to the parameters described in Example 1. The first roller had an elongated feed pipe, wherein all other features corresponded to the standard roller. The second roller also contained an elongated feed pipe, wherein the flat seal was removed from the roller. The tests were carried out with the roller heated to 20° C., 90° C., 120° C., and 150° C. The results from each of the nickel foam strips and the measurements from each roller were averaged and are shown in FIG. 10.

### Example 5: Comparison of Different Calender Rollers

The measurements of the thermal crowning of each of the three roller variants were averaged and compared at the different test temperatures. It is noteworthy that at 90° C. only the rollers with an extended feed pipe provided average thickness variations within the acceptable 1 μm tolerance for the entire working zone between position 4 and position 28. The standard rollers had average thickness variations within the allowable 1 μm tolerance between positions 8 and 26, and the rollers having modified end caps had average thickness variations within the allowable 1 μm tolerance between positions 5 and 27. The results of the test at 90° C. are shown in FIG. 11. At 120° C., rollers with an extended feed pipe had average thickness variations within the acceptable 1 μm tolerance between positions 5 and 27. For the standard rollers, the average thickness variations between positions 8 and 25 were within the allowable tolerance of 1 μm, and for the rollers having modified end caps, the average thickness variations between positions 7 and 27 were within the allowable tolerance of 1 μm. The results of the test at 120° C. are shown in FIG. 12. At 150° C., the rollers having an extended feed pipe had average thickness deviations within the allowable tolerance of 1 μm between positions 5 and 26. For the standard rollers, the average thickness variations between positions 7 and 25 were within the allowable tolerance of 1 μm, and for the rollers having modified end caps, the average thickness variations between positions 7 and 27 were within the allowable tolerance of 1 μm. The results of the test at 150° C. are shown in FIG. 13. The decrease in thermal crowning due to the expansion of the feed pipe resulted in an increase in the acceptable range of the thickness of the nickel foam strips. This results in an increase in the potential working area of the calender rollers in the manufacture of electrodes and in a larger ratio between the potential working area of the calender roller and the total length of the calender roller. By increasing the potential working area to the entire working zone, the need is eliminated to trim the edges of the manufactured electrodes, which would otherwise have poor dimensional accuracy. The ratio between the potential working area and the roller length was calculated by dividing the length of the acceptable tolerance values of the roller by the total roller length of 1,600 mm. The difference in the ratio between the working area of the calender roller and the total length of the calender roller for each roller at each temperature tested is shown in TABLE 1 below.

| | | Ratio of | Ratio of |
|---|---|---|---|
| | Ratio of working | working area to | working area to |
| | area to roller | roller length at | roller length at |
| | length at 90° C. | 120° C. | 150° C. |
| Standard roller | 0.5625 | 0.5313 | 0.5625 |
| Roller having | 0.6875 | 0.6250 | 0.6250 |
| modified end | | | |
| caps | | | |
| Roller having | 0.8125 | 0.6875 | 0.6563 |
| extended feed | | | |
| pipe | | | |

The features of the invention disclosed in the above description, in the figures, and in the claims can be essential for the implementation of the invention both individually and in any combination.

### LIST OF REFERENCE SIGNS

1 temperature-controllable calender roller
2 roller body
3 roller journal
4 fluid channel arrangement
5 central bore
6 temperature control channels
6.1 first temperature control channel
6.2 second temperature control channel
6.3 third temperature control channel
7 inlet line
8 outlet line
9 feed pipe
10 outlet gap
11 inlet channels
12 outlet channels
13 mouth area of inlet channels
14 mouth area of outlet channels
sealing bushing
16 enclosed section
17 grooves
18 axial annular groove
19 blind holes
cover cap
21 sealing element
22 cover
23 insulating sleeve
24 outlet
inlet
26 outlet
27 flat seal
28.1 O-ring
28.2 O-ring
29 bore
30 inlet gap
X axial direction

1. A temperature-controllable calender roller for manufacturing an electrode track using the dry electrode process;
having a roller body and two roller journals extending away from the end face thereof;
and having a fluid channel arrangement for temperature control of the roller body, which has a central bore extending axially at least in sections through the roller body and through at least one of the roller journals, as well as a plurality of temperature control channels distributed over the circumference of the roller body, extending below the roller body surface and parallel thereto, which are fluidically coupled to the central bore;
and having an inlet line and an outlet line for a thermal fluid, which are connected to the fluid channel arrangement, wherein the inlet line has a feed pipe extending at least in some sections into the central bore for introducing the thermal fluid into the fluid channel arrangement and wherein the outlet line is fluidically coupled to an outlet gap of the fluid channel arrangement formed between the outside of the feed pipe and the inner diameter of the central bore.

2. The temperature-controllable calender roller according to claim 1, wherein the inlet line and the outlet line open into the same roller journal of the calender roller and the temperature control channels are fluidically coupled to the feed pipe via a plurality of inlet channels and to the outlet gap via a plurality of outlet channels, wherein the inlet channels open into the central bore in a first mouth area facing away from the inlet line and the outlet channels open into the outlet gap in a second mouth area.

3. The temperature-controllable calender roller according to claim 2, wherein the outlet of the feed pipe extends axially into the central bore beyond the mouth openings of the inlet channels.

4. The temperature-controllable calender roller according to claim 1, wherein the central bore is a through bore extending through both roller journals and the roller body and the feed pipe extends into the central bore up to the area of the roller journal opposite to the feed line.

5. The temperature-controllable calender roller according to claim 2, wherein the first mouth area is sealed off from the second mouth area by means of at least one sealing bushing arranged between these areas on the outside of the feed pipe.

6. The temperature-controllable calender roller according to claim 5, wherein, on the outside of the feed pipe between the first mouth area and the second mouth area, two spaced-apart sealing bushings are arranged, due to which the section enclosed between the sealing bushings between the outside of the feed pipe and the inner diameter of the central bore is free of thermal fluid.

7. The temperature-controllable calender roller according to claim 2, wherein an odd-numbered plurality of temperature control channels spaced apart parallel to one another in the roller rotation direction is arranged between each inlet channel and the outlet channel assigned thereto, through which the thermal fluid is conducted in and against the axial direction in accordance with the number of temperature control channels.

8. The temperature-controllable calender roller according to claim 7, wherein the temperature control channels are each designed as through bores guided through the roller body and adjacent temperature control channels are connected to one another by means of essentially tangentially extending, axially sealed grooves introduced into the end face.

9. The temperature-controllable calender roller according to claim 8, wherein the roller body, in the area of the temperature control channels on both end faces of the roller body, has an axial annular groove into which a cover cap having the grooves and bores is inserted, which is axially sealed using a sealing element.

10. The temperature-controllable calender roller according to claim 9, wherein the sealing elements essentially completely cover the end faces of the roller body, and wherein the sealing elements have a thermal conductivity of less than 3 W/(m·k).

11. The temperature-controllable calender roller according to claim 4, wherein the central bore is closed at the end using a cover on the side opposite to the feed line.

12. The temperature-controllable calender roller according to claim 2, wherein the inlet channels extend in a first diagonal direction axially away from the inlet side and radially away from the central bore and the outlet channels extend in a second diagonal direction axially towards the inlet side and radially away from the central bore.

13. The temperature-controllable calender roller according to claim 1, wherein the fluid channel arrangement has, at least in the area of the roller journal comprising it, an insulating element for thermally shielding the fluid channel arrangement in relation to the roller journal.

14. The temperature-controllable calender roller according to claim 13, wherein the insulating element consists of a material having a thermal conductivity of less than 0.3 W/(m·k), such as PTFE.

15. The temperature-controllable calender roller according to claim 13, wherein the fluid channel arrangement extends at least partially through both roller journals and the fluid channel arrangement has, in the area of both roller journals, an insulating element for thermally shielding the fluid channel arrangement in relation to the respective roller journal.

16. The temperature-controllable calender roller according to claim 13, wherein the at least one insulating element is inserted into the central bore in the form of an insulating sleeve lining the central bore.

17. A process for manufacturing an electrode track, comprising the following steps:
providing a powdered electrode precursor material and at least one calender roller,
wherein the calender roller has a fluid channel arrangement for temperature control of the calender roller;
heating the calender roller by means of conducting a fluid through the fluid channel arrangement;
contacting the calender roller with the powdered electrode precursor material.

18. The process according to claim 17, wherein the fluid is an oil.

19. The process according to claim 17, wherein the fluid is kept at a temperature of 30° C. to 200° C.

20. The process according to claim 17, wherein the fluid is kept at a temperature of 60° C. to 150° C.

21. The process according to claim 17, wherein the fluid is kept at a temperature of 90° C. to 120° C.

22. The process according to claim 17, wherein to cool the calender roller, a cooling medium is conducted through the fluid channel arrangement, wherein the temperature of the cooling medium is kept at a temperature which is lower than the temperature of the calender roller.

23. A dry electrode produced by a process according to claim 17.

24. The dry electrode according to claim 23, which has a thickness tolerance of less than 1 μm.

25. A process for manufacturing a calender roller, wherein the method comprises:
manufacturing one or more calender roller parts; and
connecting the one or more calender roller parts; wherein:
the one or more calender roller parts comprise at least one feed pipe, at least one temperature control channel, and at least one outlet line;
wherein the calender roller has a first end and a second end; and
the at least one feed pipe extends from the first end into the second end.

26. The process according to claim 25, wherein the one or more calender roller parts are manufactured by CNC machining, forging, investment casting, injection molding, die casting, additive manufacturing, or combinations thereof.

27. The process according to claim 25, wherein the one or more calender roller parts are connected by metal gas welding, arc welding, tungsten inert gas welding, flux core welding, soldering, mixing, adhesive bonding, or combinations thereof.

28. The process according to claim 25, which furthermore comprises manufacturing at least one insulating sleeve and connecting the insulating sleeve to the one or more calender roller parts, wherein
the at least one insulating sleeve is manufactured by transfer molding, injection molding, melt molding, compression molding, vacuum forming, pultrusion, or combinations thereof; and
the at least one insulating sleeve is connected to the one or more calender roller parts by adhesive bonding, mechanical fastening, or combinations thereof.

29. The process according to claim 25, which furthermore comprises manufacturing at least one insulating layer and connecting the insulating layer to the one or more calender roller parts, wherein
the at least one insulating layer is manufactured by transfer molding, injection molding, melt molding, compression molding, vacuum forming, pultrusion or combinations thereof; and
the at least one insulating layer is connected to the one or more calender roller parts by adhesive bonding, mechanical fastening, or combinations thereof.

30. The process according to claim 25, wherein the calender roller has a surface, furthermore comprising treating the surface of the calender roller, wherein the surface of the calender roller is treated using a micro-etching treatment, a laser engraving treatment, a superpolishing treatment, or combinations thereof.
